(19) United States
(12) Patent Application Publication
(10) Pub. No.: US 2008/0029985 A1
(43) Pub. Date: Feb. 7, 2008

(54) Side movement propelled wheeled recreational device

(76) Inventor: Shane Chen, Camas, WA (US)

Correspondence Address: STEVEN J. ADAMSON, PC, P.O. BOX 5997, PORTLAND, OR, 97228, US

(21) Appl. No.: 11/656,897

(22) Filed: Jan. 22, 2007

Related U.S. Application Data
(60) Provisional application No. 60/760,638, filed on Jan. 21, 2006.

(51) Int. Cl. B62M 1/00

(52) U.S. Cl. 280/87.042

(57) ABSTRACT

A recreational board propelled by side-to-side movement of a user. The board may be wider than deep, to accommodate a human standing at a slight straddle, and have a plurality of caster wheels mounted to an underside thereof. The wheels are preferably mounted in a biased direction wheel arrangement, the bias being provided by tilting, spring or other mechanism. The orientation of the front wheels may be different from that of the rear wheels. Four, six and eight wheel embodiments are disclosed.

### CROSS REFERENCE TO RELATED APPLICATIONS

This application claims the benefit of earlier filed U.S. Provisional Patent Application No. 60/760,638, filed Jan. 21, 2006, and having the same title and inventor as above.

### FIELD OF THE INVENTION

The present invention relates to a board or other structure having skate wheels or the like that is self propelled in a forward trajectory by side-to-side movement.

### BACKGROUND OF THE INVENTION

The prior art contains many different types of wheeled recreational devices, including skate boards and a collection of three-wheeled scooters or “cambering vehicles,” the latter being propelled by side-to-side movement.

Skate boards tend to have a longitudinal axis and travel in a line-of-direction substantially aligned with that longitudinal axis. Forward travel is typically achieved by a push and coast movement, with a user pushing off the ground, placing the push foot on the board, and coasting until slow, then repeating. These types of devices require a user to continually remove their foot from the board and push off of a resistant substrate to attain forward propulsion. These devices tend to be well suited for sidewalk and street travel, but may be less suited for smaller or more restricted spaces.

The cambering vehicles or the like tend to have three wheels, with a turnable front wheel and a handle bar for steering (similar to a conventional tri-cycle). While these vehicles may be propelled by side to side movement, they include a steering infrastructure, relatively extensive vertical supports and controls, and a limited wheel-base.

The self-propelled wheeled device of the present invention is compact, relatively lightweight, and physically small in profile. In contrast to a conventional skate board, the present invention achieves forward propulsion in a manner that does not require a user to continually step on and off a board. With the present invention, a user leaves both feet positioned on the board or “platform” and achieves forward propulsion by shifting his or her weight from side to side. The present invention thus provides an alternative transportation method and different recreational outlets.

Among other features and benefits, the present invention increases recreational opportunities available to youth (and to adults). For example, as we live at higher population densities, there is less space available to children and adults for recreational and/or physical exercise opportunities. Our less active lifestyles are further influenced by automobile travel (not self-propelled) and time in front of a television or computer. This lack of physical movement is deleterious to overall health. The present invention, due to its compact size, low weight and small profile, is well suited for use in or on the hard surfaces and restricted spaces of the urban and suburban landscape, thus providing needed recreational and exercise opportunities to youth (and others) living there.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-4 are an upside down perspective view, a side elevation view, a detailed cut-away view, and a bottom plan view, respectively, of one embodiment of a side movement propelled wheeled device 10 in accordance with the present invention.

FIGS. 5-8 are an upside down perspective view, a side elevation view, a detailed cut-away view, and a bottom plan view, respectively, of another embodiment of a side movement propelled wheeled device 10 in accordance with the present invention.

FIGS. 9-11 are an upside down perspective view, a side elevation view, a detailed cut-away view, and a bottom plan view, respectively, of another embodiment of a side movement propelled wheeled device 10 in accordance with the present invention.

FIG. 12 is a bottom perspective view of an alternative four wheel side movement propelled device in accordance with the present invention.

FIG. 13 is a bottom perspective view of a six wheel side movement propelled device in accordance with the present invention.

FIG. 14 is a bottom perspective view of a eight wheel side movement propelled device in accordance with the present invention.

### DETAILED DESCRIPTION

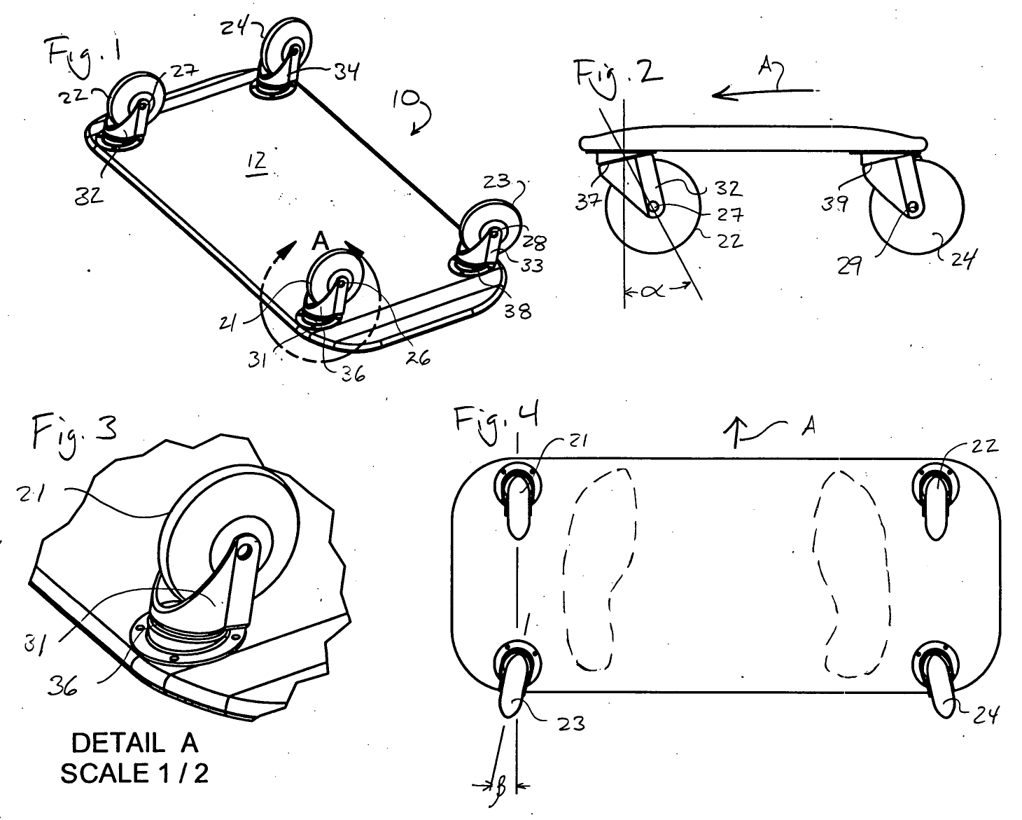

Referring to FIGS. 1-4, an upside down perspective view, a side elevation view, a detailed cut-away view, and a bottom plan view, respectively, of a side movement propelled wheeled device 10 in accordance with the present invention is shown.

Device 10 may include a platform or board 12 that acts as a support structure, receiving a human in a standing position (feet shown in phantom in FIG. 4) and supporting the wheels 21-24 in a fixed relative position. The wheels (and bearings) may be a conventional skate wheel. Many are known in the art and are available commercially. Wheels 21-24 are preferably coupled via casters 31-34, respectively, to platform 12.

Referring to FIG. 2, it can be seen that in device 10 each caster is preferably tilted backwards. The pivot point of caster rotation is located on the backward tilted caster mounting plate 36-39 and the pivot or axle 26-29 of each wheel 21-24 (in a default position) is located rearward of the pivot point of caster rotation. Each caster may be tilted at an angle, α. This angle may be 1-45 degrees and is preferably between 5-35 degrees. In one embodiment, α for the front wheels is approximately 18 degrees while α for the back wheels is approximately 15 degrees. The difference in α is due to the offset of the rear wheels (see discussion below with reference to FIG. 4). Since the rear wheels are offset, the height of the platform over the rear wheels would be slightly less than the front wheels if α were the same. Decreasing α a small amount for the rear wheels overcomes the height difference otherwise resulting from the offset.

The tilt of the caster mounting plate causes each respective wheel to be biased, under weight, towards alignment with a line traversing the lowest and highest points of its respective caster mounting plate. FIG. 2 illustrates that the wheels are generally biased in line with a general line of forward travel of the device, indicated by arrow A. Closer inspection of the rear wheels 23-24 shows that they are preferably slightly offset (by an angle, β, discussed below).

FIG. 4 illustrates that the two front wheels 21-22 are substantially aligned in parallel with the “straight ahead” direction of travel of device 10. The rear wheels are preferably offset from this line by an angle, β. This angle may range from a degree to nearly 90 degrees. In a preferred embodiment the range may be from a few degrees to several dozen or more. In the embodiment of FIG. 4, the offset is between 5 and 25 degrees, more preferably between 10 and 15 and even more preferably about 12 degrees.

The front wheels are offset at 0 degrees, yet may be otherwise offset. While the rear wheels preferably have an angle great than 0 degrees, the angle of the rear wheels may be 0 without departing from the present invention.

In use, device 10 is turned over from the position shown in FIG. 4 and a user stands with a foot located on each side (as roughly indicated by the phantom lines). To achieve initial forward movement, a user may push off the ground with one foot before placing it on the platform, though an initial push off is not necessary.

From the legs apart or “slightly-straddled” position, a user shifts his or her weight from side to side, effectively pushing off one foot and then the other, in a motion similar to ice skating. This force propels the device forward. Continued operator movement in this side to side, ice-skating manner produces a repeated forward movement thrust that in aggregate propels the device and user ahead at a smooth velocity.

Turning may be achieved by holding the push-off position on one side (for an increased length of time) or more rapidly by placing a foot outside the front and back wheels on one side and leaning to that side, lifting the opposite wheels off the ground and rotating the platform about the two wheels still contacting the ground, in much the same manner as one rapidly turns a conventional skate board.

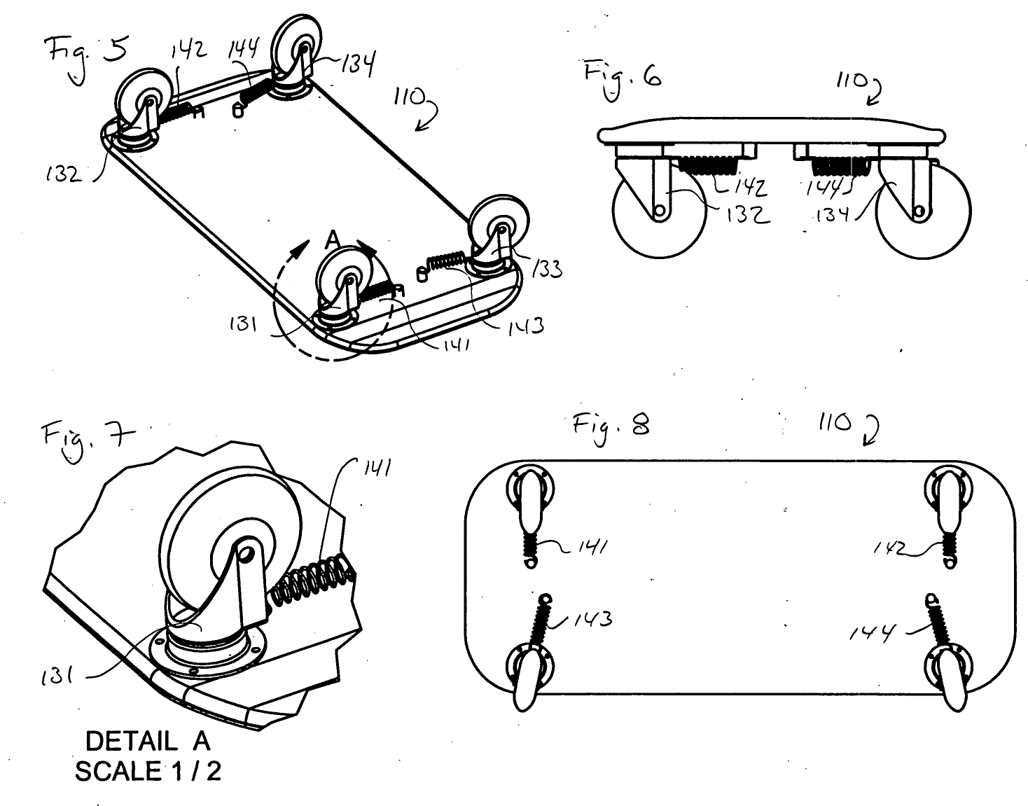

FIGS. 5-8 are an upside down perspective view, a side elevation view, a detailed cut-away view, and a bottom plan view, respectively, of another embodiment of a side movement propelled wheeled device 110 in accordance with the present invention.

Device 110 of FIGS. 5-8 is similar to device 10 of FIGS. 1-4. A difference is that the casters 131-134 are not biased by tilting, but rather biased by springs 141-144. Springs 141-144 may be any suitable coil spring or any other type of spring or other bias device. In essence, they represent mechanical biasing of the wheels by spring or elastic material or other suitable mechanism.

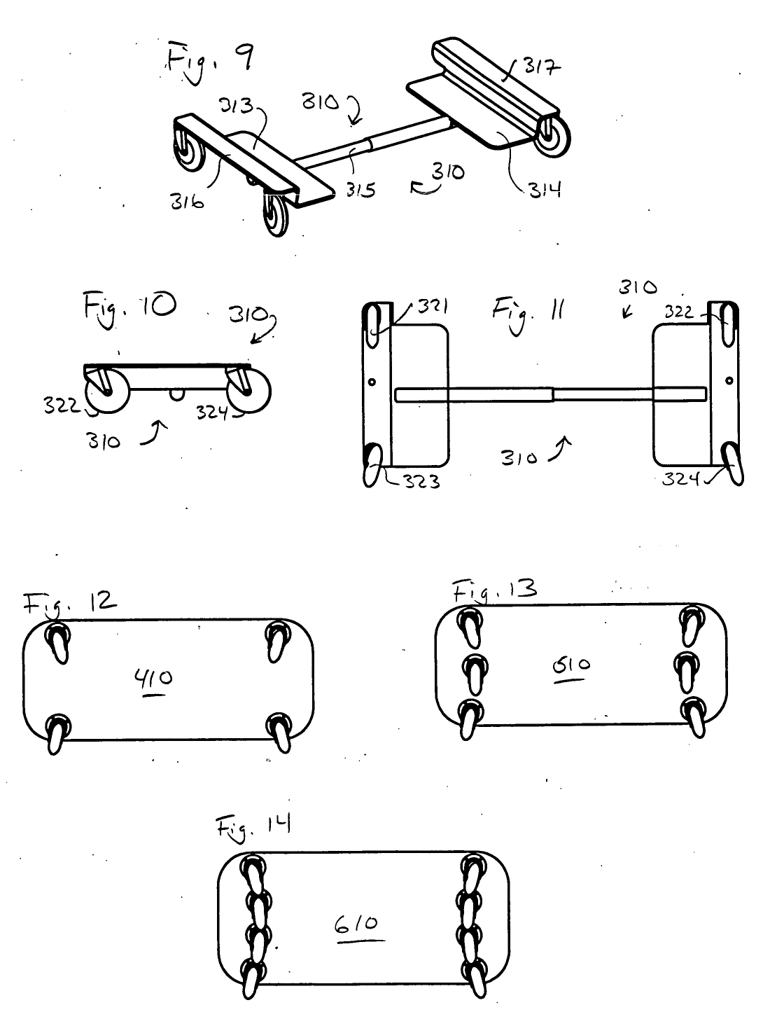

FIGS. 9-11 are a top perspective view, a side elevation view, and a bottom plan view, respectively, of another embodiment of a side movement propelled wheeled device 310 in accordance with the present invention.

In device 310, the platform 312 is comprised of two foot plates 313-314, an adjustable-distance connecting rod 315 and two hubs 316-317. FIG. 11 illustrates that wheels 321-324 and casters 331-334 are arranged in a manner similar to that disclosed with reference to device 10 of in FIGS. 1-4.

Referring to FIG. 12, a bottom perspective view of an alternative four wheel side movement propelled device 410 in accordance with the present invention is shown. In device 410, the front wheels are slightly offset in a direction generally opposite that of the rear wheels, i.e., if the rear wheels are angled out, the front wheels are angled in.

Referring to FIG. 13, a bottom perspective view of a six wheel side movement propelled device 510 in accordance with the present invention is shown. In device 510, the front and rear wheels are slightly offset in generally opposite directions (as discussed with reference to FIG. 12) and the center wheels are not substantially offset.

Referring to FIG. 14, a bottom perspective view of an eight wheel side movement propelled device 610 in accordance with the present invention is shown. In device 610, the outer front and rear wheels are offset more than the inner front and rear wheels.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A side movement propelled recreational wheeled board device, comprising:
a board sufficient in size to accommodate a standing human:
at least four caster wheels mounted to an under side of the board, the four caster wheels moving independently and being spaced from one another;
wherein the four caster wheels are mounted in a biased direction wheel arrangement.

2. The device of claim 1, wherein the biased direction wheel arrangement includes a tilted caster wheel arrangement.

3. The device of claim 1, wherein the biased direction wheel arrangement includes a spring biasing caster wheel arrangement.

4. The device of claim 1, wherein the orientation towards which two of the wheels are biased is different from that of the other two wheels.

5. The device of claim 1, wherein the castered wheels are arranged in a rectangular or polygonal alignment.

6. The device of claim 1, wherein the board has a dimension perpendicular to the line of direction of travel that is greater than that parallel to the line of direction.

7. The device of claim 4, wherein two of the wheels are angled outward relative to a line parallel to the direction of travel and the other two of the wheels are angled inward relative to a line parallel to the direction of travel.

8. The device of claim 1, including at least six caster wheels, each mounted in a biased direction wheel arrangement, and wherein at least three of the caster wheels are provided on a right side of the board and at least three caster wheels are provided on a left side of the board.

9. A side movement propelled recreational wheeled board device, comprising:
a board;
at least four wheels coupled to the board and positioned such that two wheels are front wheels and two wheels are rear wheels;
wherein each of the wheels is mounted in a biased direction wheel arrangement and the front wheels are oriented in a first orientation relative to the line of straight-forward travel and the rear wheels are oriented in a second orientation, the first orientation being different from the second orientation.

10. The device of claim 9, wherein the front wheels are oriented substantially in parallel with a straight-ahead line of travel of the device and the rear wheels are oriented at an outwardly disposed angle from the straight-forward line of travel.

11. The device of claim 9, wherein the front wheels are oriented at an angle greater than zero degrees from the straight-forward line of travel and the rear wheels are oriented at an angle greater than zero degrees from the straight-forward line of travel, the angle of the front wheels, in size or relative orientation, being different from that of the rear wheels.

12. The device of claim 9, wherein the biased direction wheel arrangement includes a tilted caster wheel arrangement.

13. The device of claim 9, wherein the biased direction wheel arrangement includes a spring biasing caster wheel arrangement.

14. The device of claim 9, wherein the caster wheels are arranged in a rectangular or polygonal alignment.

15. The device of claim 9, wherein the board has a dimension perpendicular to the line of direction of straight forward travel that is greater than that parallel to the line of direction of straight forward travel.

16. The device of claim 9, including at least six wheels, each mounted in a biased direction wheel arrangement, and wherein at least three of the caster wheels are provided on a right side of the board and at least three caster wheels are provided on a left side of the board.
